(19) United States
(12) Patent Application Publication
(10) Pub. No.: US 2018/0170821 A1
(43) Pub. Date: Jun. 21, 2018

(54) PROPELLANT

(71) Applicant: GOODRICH CORPORATION, Charlotte, NC (US)

(72) Inventors: Karl G. Reimer, Fairfield, CA (US); Jean C. Rodriguez, Vallejo, CA (US)

(73) Assignee: GOODRICH CORPORATION, Charlotte, NC (US)

(21) Appl. No.: 15/379,655

(22) Filed: Dec. 15, 2016

(51) Int. Cl. C06B 29/02; C06B 29/08; C06B 29/16; F02K 9/34

(52) U.S. Cl. CPC C06B 29/02; C06B 29/08; C06B 29/16; F05D 2300/174; F05D 2220/80; F05D 2300/173; F02K 9/34

(57) ABSTRACT

A propellant may comprise a primary oxidizer having a density of greater than or equal to 2.7 grams per cubic centimeter; a secondary oxidizer having a density of less than 2.7 grams per cubic centimeter; and/or a fuel comprising at least one of zirconium metal, tin metal, titanium metal, aluminum metal, magnesium metal, or a metal hydride. The propellant may be substantially free of lead.

### FIELD

This disclosure relates to systems and methods for a propellant.

### BACKGROUND

Desirable characteristics of a propellant, such as a propellant used in a rocket motor, for example, may be a high density allowing more efficient packing into small areas and/or a rapid burn rate. Traditionally, propellants exhibiting the desired properties (i.e., desired density, burn rate, impulse, etc.) contain lead, which is toxic and poses health risks during both the manufacturing of the propellant and the burning of the propellant in a rocket motor. Previous attempts to create a lead-free propellant achieving sufficient density, burn rate, and/or impulse have been unsuccessful.

### SUMMARY

In various embodiments, a propellant may comprise a primary oxidizer having a density of greater than or equal to 2.7 grams per cubic centimeter; and a fuel comprising at least one of zirconium metal, tin metal, tungsten metal, zinc metal, titanium metal, aluminum metal, magnesium metal, magnalium metal alloy, or a metal hydride. The propellant may be substantially free of lead. In various embodiments, the propellant may comprise a secondary oxidizer having a density of less than 2.7 grams per cubic centimeter.

In various embodiments, the primary oxidizer may comprise at least one of potassium iodate, potassium periodate, cesium iodate, cesium periodate, cupric iodate, copper periodate, or ammonium iodate. In various embodiments, the secondary oxidizer may comprise at least one of potassium perchlorate or ammonium perchlorate. In various embodiments, the propellant may comprise about 50% to about 90% by weight primary oxidizer. In various embodiments, the propellant may comprise about 1% to about 50% by weight secondary oxidizer. In various embodiments, the propellant may comprise 2% to 30% by weight fuel.

In various embodiments, the propellant may further comprise a binder comprising at least one of polyurethane, hydroxyl terminated polybutadiene, or hydroxyl terminated polyether. In various embodiments, the propellant may comprise 3% to 14% by weight binder. In various embodiments, the propellant may further comprise a plasticizer comprising at least one of trimethyloethane trinitrate, triethyleneglycol dinitrate, butannetriol trinitrate, diethylene glycol dinitrate, n-butyl-2-nitratoethyl nitramine, 2,4-dinitro ethyl benzene, 2,4,6-trinitro ethyl benzene, dioctyl adipate, dibutyl phthalate, or isodecyl pelargonate. In various embodiments, the propellant may comprise about 2% to about 18% by weight plasticizer. In various embodiments, the plasticizer may comprise about 50% by weight 2,4-dinitro ethyl benzene and about 50% by weight 2,4,6-trinitro ethyl benzene, and/or.

In various embodiments, a rocket motor may comprise a motor casing; a propellant chamber within the motor casing; and a propellant disposed within the propellant chamber. The propellant may comprise a primary oxidizer having a density of greater than or equal to 2.7 grams per cubic centimeter; and a fuel comprising at least one of zirconium metal, tin metal, tungsten metal, zinc metal, titanium metal, aluminum metal, magnesium metal, magnalium metal alloy, or a metal hydride. The propellant may be substantially free of lead. In various embodiments, the propellant may comprise a secondary oxidizer having a density of less than 2.7 grams per cubic centimeter.

In various embodiments, the primary oxidizer of the propellant may comprise at least one of potassium iodate, potassium periodate, cesium iodate, cesium periodate, cupric iodate, copper periodate, or ammonium iodate. The secondary oxidizer of the propellant may comprise at least one of potassium perchlorate or ammonium perchlorate. In various embodiments, the propellant may comprise about 50% to about 90% by weight primary oxidizer. In various embodiments, the propellant may comprise about 1% to about 50% by weight secondary oxidizer. In various embodiments, the propellant may comprise about 2% to about 30% by weight fuel. In various embodiments, the propellant may further comprise a binder comprising at least one of polyurethane, hydroxyl terminated polybutadiene, or hydroxyl terminated polyether. In various embodiments, the propellant may further comprise a plasticizer comprising at least one of trimethyloethane trinitrate, triethyleneglycol dinitrate, butannetriol trinitrate, diethylene glycol dinitrate, n-butyl-2-nitratoethyl nitramine, 2,4-dinitro ethyl benzene, or 2,4,6-trinitro ethyl benzene.

In various embodiments, a method of making a propellant may comprise forming an oxidizer mixture by mixing a primary oxidizer and a secondary oxidizer, wherein the primary oxidizer has a density of greater than or equal to 2.7 grams per cubic centimeter and the secondary oxidizer has a density of less than 2.7 grams per cubic centimeter; and mixing the oxidizer mixture with a fuel and a binder, wherein the fuel comprises at least one of zirconium metal, tin metal, tungsten metal, zinc metal, titanium metal, aluminum metal, magnesium metal, magnalium metal alloy, or a metal hydride, and the binder comprises at least one of polyurethane, hydroxyl terminated polybutadiene, or hydroxyl terminated polyether.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures. In the figures, like referenced numerals may refer to like parts throughout the different figures unless otherwise specified.

FIG. 1 illustrates a rocket motor, in accordance with various embodiments; and

FIG. 2 illustrates a method for making a propellant, in accordance with various embodiments; and

FIG. 3 illustrates a method for making a rocket motor, in accordance with various embodiments.

### DETAILED DESCRIPTION

All ranges may include the upper and lower values, and all ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

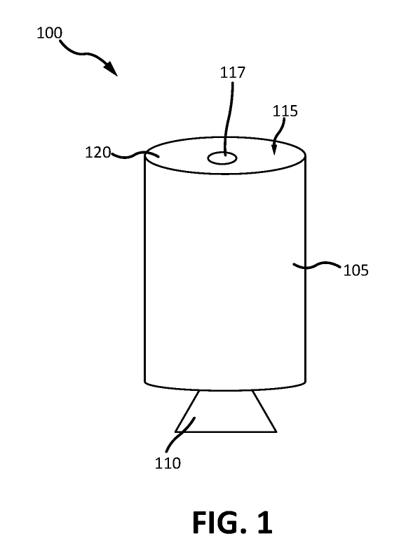

In various embodiments, with reference to FIG. 1, a rocket motor 100 may comprise a motor casing 105, a nozzle 110 coupled to motor casing 105, and a propellant chamber 115 within motor casing 105. A propellant 120 may be disposed within propellant chamber 115. Propellant 120 in rocket motor 100 may comprise a cavity 117 through a length of propellant 120, which may be formed by the presence of a mandrel during casting of propellant 120 into motor casing 105.

In operation, propellant 120 may be ignited by an igniter disposed in cavity 117. Propellant 120 may burn, emitting gas which is directed through nozzle 110, creating thrust. Accordingly, propellant 120 has a burning rate which produces a sufficient amount of gas in a given amount of time to create a desired thrust and corresponding impulse (impulse being the integral of the force produced over the time the rocket motor is functioning). Additionally, given the limited space provided in a propellant chamber 115, it is desirable for propellant 120 to comprise a high density material (i.e., a density greater than or equal to 2.7 grams per cubic centimeter (g/cc)). Propellants comprising a high density material allow a greater amount of such a propellant to be packed into propellant chamber 115 than propellants comprising materials with relatively lower densities. The greater the amount of propellant packed into propellant chamber 115, the greater the impulse which may be produced from the rocket motor.

In various embodiments, a propellant may comprise a primary oxidizer, a secondary oxidizer, a fuel, a binder, and/or a plasticizer. The primary oxidizer may comprise a material having a high density (i.e., a density equal to or greater than 2.7 grams per cubic centimeter (g/cc)). The secondary oxidizer may comprise a material having a lower density (i.e., a density less than 2.7 g/cc). The primary oxidizer having a high density allows more propellant 120 to be better packed into propellant chamber 115. However, as a result of the high densities of primary oxidizers, the primary oxidizer(s) in propellant 120 may have a slower burn rate than the secondary oxidizer(s). Burning rate may refer to the linear combustion rate of a propellant measured in length per unit time (typically tested/measured under pressure) (e.g., a propellant may have a burn rate of 3 inches per second). The slower burning rate of primary oxidizers, burning in a rocket motor, may not create a sufficient amount of gas in a given time to produce a desired thrust. Therefore, a secondary oxidizer, having a greater burning rate may be included in propellant 120 to achieve the desired gas generation and kinetic properties of the rocket motor (e.g., thrust, impulse, etc.). The secondary oxidizer may, however, cause the density of the propellant to decrease, allowing less propellant to be packed into a confined area, such as a rocket motor.

In various embodiments, the primary oxidizer may comprise cesium iodate cesium periodate, potassium periodate, cupric iodate, copper periodate, potassium iodate, bismuth trioxide, cesium nitrate, strontium nitrate, ammonium iodate, ammonium nitrate, or mixtures thereof. A propellant may comprise about 50% to about 90% by weight primary oxidizer, about 55% to about 80% by weight primary oxidizer, or about 60% to about 70% by weight primary oxidizer. As used in this context only, the term “about” means plus or minus 10% by weight.

In various embodiments, a secondary oxidizer may comprise potassium perchlorate, potassium nitrate, ammonium nitrate, ammonium perchlorate, guanidine nitrate, or mixtures thereof. In various embodiments, a propellant may not comprise a secondary oxidizer. In various embodiments, a propellant may comprise about 1% to about 50% by weight secondary oxidizer, about 1% to about 25% by weight secondary oxidizer, or about 2% to about 10% by weight secondary oxidizer. In this context only, the term “about” means plus or minus 0.5% by weight. The primary oxidizer and/or the secondary oxidizer in propellant 120 may comprise particles having particle sizes ranging from 1 micron (0.00004 inch) to 300 microns (0.01 inch), 3 microns (0.0001 inch) to 300 microns (0.01 inch), 3 microns (0.0001 inch) to 10 microns (0.0004 inch), 25 microns (0.001 inch) to 50 microns (0.002 inch), and/or 50 (0.002 inch) to 200 microns (0.008 inch). In various embodiments, the particles making up the primary and secondary oxidizers may comprise a particles within a single size range, or particles within multiple size ranges (e.g., 60% of the primary oxidizer particles may comprise a particle size of 3 microns (0.0001 inch) to 8 microns (0.0003 inch), and 40% may comprise a particle size of 25 microns (0.001 inch) to 50 microns (0.002 inch)). For the various particle size ranges recited herein, the particles in a given sample may have particles sizes having a standard deviation of one-fourth of the mean particle size for that given sample.

In various embodiments, the fuel of propellant 120 may comprise any suitable elemental metal and/or metal hydride. For example, propellant 120 may comprise zirconium metal, zirconium hydride, titanium metal, titanium hydride, tin metal, tin hydride, aluminum metal, magnesium metal, tungsten metal, zinc metal, or mixtures thereof. In various embodiments, the fuel may comprise magnalium metal alloy (50% by weight magnesium metal and 50% by weight aluminum metal), instead of, or in addition to, any suitable elemental metal and/or metal hydride. In various embodiments, propellant 120 may comprise 2% to 30% by weight fuel, 2% to 25% by weight fuel, 4% to 20% by weight fuel, or 6% to 15% by weight fuel. The particle size of the fuel may range from 0.01 micron (3.94e⁻⁷ inch) to 50 microns (0.002 inch), 5 microns (0.0002 inch) to 40 microns (0.0016 inch), or 10 microns (0.0004 inch) to 30 microns (0.001). In various embodiments, the fuel may comprise 100% by weight aluminum metal. In various embodiments, the fuel may comprise aluminum metal and zirconium metal and/or zirconium hydride. In such embodiments, the fuel may comprise 40% to 90% by weight aluminum metal, 50% to 70% by weight aluminum metal, or 52% to 66% by weight aluminum metal, and 10% to 60% by weight zirconium metal, 30% to 50% by weight zirconium metal, and/or 35% to 47% by weight zirconium metal. In various embodiments, the fuel may comprise aluminum metal and tin metal. In such embodiments, the fuel may comprise 30% to 98% by weight aluminum metal, 40% to 86% by weight aluminum metal, or 60% to 78% by weight aluminum metal, and 2% to 70% by weight tin metal, 14% to 60% by weight tin metal, or 22% to 40% by weight tin metal.

In various embodiments, propellant 120 may comprise a binder. The binder may be configured to aggregate the particles of the primary oxidizer, secondary oxidizer and/or fuel, while lowering the viscosity of the resulting mixture, which may allow more efficient packing of propellant 120 into propellant chamber 115. In various embodiments, the binder may comprise any suitable material, including polyurethanes, hydroxyl terminated polybutadienes, and/or hydroxyl terminated polyethers. In various embodiments, propellant 120 may comprise 3% to 14% by weight binder, 4% to 14% by weight binder, 6% to 12% by weight binder, or 8% to 10% by weight binder.

In various embodiments, propellant 120 may comprise a plasticizer. The plasticizer may be configured to further decrease the viscosity of the propellant (for example, prior to curing), which may allow better processing and packing into propellant chamber 115. Additionally, the plasticizer may improve the mechanical performance of the propellant under a wide range of temperatures after the propellant is cured. For example, a rocket motor may function between −40° F. (−40° C.) and 160° F. (71° C.). In relatively colder temperatures, a cured propellant 120 in rocket motor 100 may be prone to cracking, especially resulting from the rapid increase in pressure, shock, and/or vibration in a rocket motor during rocket operation. Any cracking of propellant 120 or release from propellant chamber 115 (case-liner propellant separation) creates additional surface area within propellant 120, which may result accelerated gas generation, which may further result in mal-performance or detonation of propellant 120 rather than a systematic burning. Therefore, the addition of a plasticizer to propellant 120 may improve performance at lower temperatures, decreasing the risk of propellant cracking and detonation during rocket operation.

In various embodiments, a plasticizer may comprise trimethyloethane trinitrate (TMETN), triethyleneglycol dinitrate (TEGDN), butannetriol trinitrate (BTTN), diethylene glycol dinitrate (DEGDN), n-butyl-2-nitratoethyl nitramine (BuNENA), 2,4-dinitro ethyl benzene, 2,4,6-trinitro ethyl benzene, dioctyl adipate, dibutyl phthalate, isodecyl pelargonate, or mixtures thereof. In various embodiments, a propellant may comprise 2% to 18% by weight plasticizer, 5% to 14% by weight plasticizer, or 7% to 12% by weight plasticizer. In various embodiments, the plasticizer may comprise a first mixture comprising about 50% by weight 2,4-dinitro ethyl benzene and about 50% by weight 2,4,6-trinitro ethyl benzene. In various embodiments, the plasticizer may comprise a second mixture comprising about 50% by weight TMETN and about 50% by weight TEGDN (with or without the first mixture comprised in the plasticizer). In various embodiments, the plasticizer may comprise about 50% by weight TMETN, about 25% by weight 2,4-dinitro ethyl benzene, and about 25% by weight 2,4,6-trinitro ethyl benzene. As used in this context only, the term “about” means plus or minus 10% by weight.

The binder(s) and/or plasticizer(s) comprised in the propellant may be energetic, in that they are decomposed during the burning of the propellant, along with the primary and secondary oxidizers and the fuel, to produce gas. Accordingly, the binder(s) and/or plasticizer(s) may contribute to the generation of thrust and impulse by the propellant.

In various embodiments, a propellant may comprise 60% to 68% by weight primary oxidizer, 2% to 10% by weight secondary oxidizer, 6% to 15% by weight fuel, 4% to 14% by weight binder, and/or 7% to 12% by weight plasticizer. In various embodiments, a propellant may comprise 64% by weight primary oxidizer, 6% by weight secondary oxidizer, 10% by weight fuel, 9% by weight binder, and/or 9% by weight plasticizer. The primary oxidizer may be potassium iodate, potassium periodate, cesium periodate, and combinations thereof. The secondary oxidizer may be potassium perchlorate, ammonium perchlorate and combinations thereof. The fuel may comprise aluminum metal, aluminum metal and zirconium metal, aluminum metal and zirconium hydride, aluminum metal and tin metal, or aluminum metal and titanium hydride. The binder may be polyurethane, hydroxyl terminated polybutadiene, hydroxyl terminated polyether and combinations thereof. The plasticizer may be TMETN and TEGDN, or TMETN and n-butyl-2-nitratoethyl nitramine, 2,4-dinitro ethyl benzene and 2,4,6-trinitro ethyl benzene, or n-butyl-2-nitratoethyl nitramine, 2,4-dinitro ethyl benzene and 2,4,6-trinitro ethyl benzene, or BuNENA.

In various embodiments, a propellant may comprise one or more additional ingredients, which may comprise less than or equal to about 3% by weight of the propellant. As used in this context only, the term “about” means plus or minus 1% by weight. Other ingredients of a propellant may comprise a burning rate modifier or catalyst (e.g., ferric oxide, copper oxide, and/or cesium dodecahydrododecaborate, and/or any other suitable material), a stabilizer (e.g., diphenylamine, ethyl centralite/diethyl diphenyl urea, e-nitrodiphenylamine, n-methyl-4-nitroaniline, and/or any other suitable material), an antioxidant (e.g., N-phenyl-B-naphthylamine, dioctyldiphenylamine, 2′-methylenebis (4-methyl)-6-t-butylphenol, and/or any other suitable material), an opacifier (e.g., carbon black and/or any other suitable material), a cure catalyst (triphenyl bismuth, dibutyltin dilaurate, or any other suitable material), a curative (e.g., an iscyanate(s), an amine(s), and/or any other suitable material), and/or a bonding agent (e.g., tris [1-(2-methylaziridinyl) phosphine oxide], 12-hydroxystearic acid, and/or any other suitable material).

In various embodiments, propellant 120 may be substantially free of lead. As used herein, “substantially free” means less than 0.01% by weight. In various embodiments, propellant 120 may be completely free of lead. Therefore, propellant 120 may pose fewer health risks during the manufacture or burning of propellant 120 than that posed by traditional lead-containing propellants.

TABLE 1 displays three propellants A-C comprising greater than 50% by weight lead nitrate oxidizers as compared to a substantially lead-free propellant D.

TABLE 1

| Propellant | Density (g/cc) | Density Impulse (g*s/cc) |
|---|---|---|
| A | 2.83 | 557 |
| B | 2.80 | 554 |
| C | 2.87 | 507 |
| D | 3.14 | 564 |

Propellant D comprises a primary oxidizer comprising copper periodate, a secondary oxidizer comprising potassium perchlorate, a fuel comprising aluminum metal and zirconium hydride, a polyurethane binder, and 2,4-dinitro ethyl benzene and 2,4,6-trinitro ethyl benzene plasticizers. As indicated in TABLE 1, density of propellant D is higher than the lead-containing propellants A-C, which allows for better packing of propellant D into a propellant chamber, and thus, a greater amount of propellant D into a confined space than propellants A-C. Additionally, the density impulse of propellant D is higher than propellants A-C. The density impulse is the specific impulse of the rocket motor comprising the propellant times the density of the propellant, wherein the specific impulse is the rocket motor impulse divided by the weight of the propellant, and wherein the impulse is the integral of the force of the rocket motor is providing over the time the rocket motor is operating. Therefore, the density impulse of the propellant reflects the force produced by the rocket motor, the time the rocket motor functions, the propellant weight (amount), and the propellant density. Propellant D having a greater density impulse than propellants A-C shows that propellant D has a denser propellant, which requires less weight (amount) and/or volume of the propellant to produce the same amount or more force during the time the rocket motor is operating.

Traditional, lead-containing propellants exhibit desirable kinetic properties (e.g., burn rate and impulse), and sufficient amounts of such lead-containing propellants are able to be packed into a container of fixed volume because of the propellant density (due, in part, to the high density of the primary oxidizer, lead nitrate, which is 4.53 g/cc). As described herein, however, lead-containing propellants pose serious health risks, but attempts to produce lead-free propellants exhibiting similar properties to lead-containing propellants have been heretofore unsuccessful. In various embodiments, formulations of a propellant described herein may include primary oxidizers which have significantly lower densities than lead nitrate. For example, cesium periodate has a density of 4.26 g/cc, potassium periodate has a density of 3.62 g/cc, and potassium iodate has a density of 3.89 g/cc. However, the components of the propellant described herein comprising the primary and secondary oxidizers, the fuel, binder, and/or plasticizer come together to form propellants with higher densities than those lead-containing propellants. On the other hand, in various embodiments, formulations of a propellant described herein may include a primary oxidizer(s) having significantly greater densities than lead nitrate. For example, cupric iodate has a density of 5.09 g/cc and copper periodate has a density of 5.26 g/cc. In embodiments in which the primary oxidizer has a greater density than lead nitrate, the other components in the propellant need not be as dense (e.g., may use aluminum metal (2.70 g/cc) in the fuel instead of tin metal (7.31 g/cc)) to form a propellant with a higher density than those lead-containing propellants. Thus, the resultant high density propellants described herein are able to be packed into a container of fixed volume, despite individual components of the propellant having relatively lower densities. Additionally, the propellants described herein achieve sufficient kinetic properties (due, in part, to each component of the propellant being energetic), making the substantially lead-free propellants described herein viable replacements for lead-containing propellants.

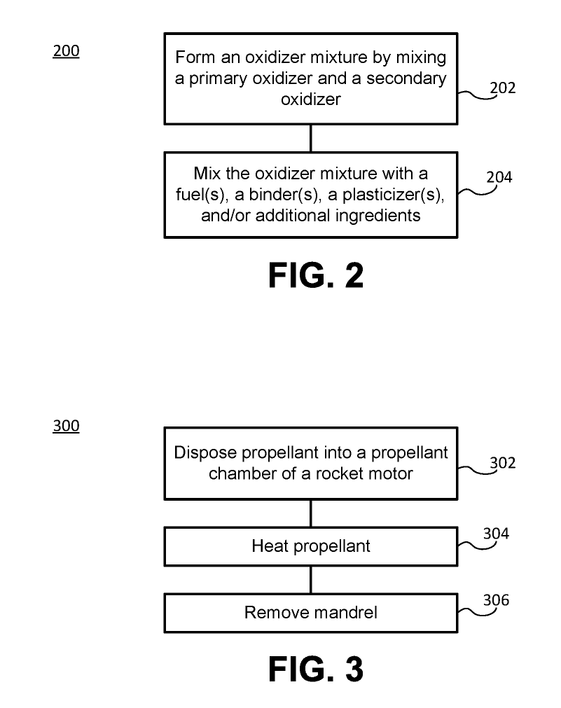

FIG. 2 depicts a method 200 for making a propellant, in accordance with various embodiments. In various embodiments, an oxidizer mixture may be formed by mixing a primary oxidizer with a secondary oxidizer (step 202). The primary and secondary oxidizers may be any material described herein. The oxidizer mixture may be mixed with a fuel(s), a binder(s), a plasticizer(s), and/or additional ingredients (step 204) to create the propellant. The fuel, binder, and plasticizer may be any of the materials described herein. The propellant may comprise any weight percent of the primary oxidizer, secondary oxidizer, fuel, binder, and/or plasticizer as described herein. In various embodiments, the components of the propellant may be mixed simultaneously (i.e., without first mixing the primary and secondary oxidizers to form the oxidizer mixture), or in any suitable order.

FIG. 3 depicts a method 300 for making a rocket motor, in accordance with various embodiments. With combined reference to FIGS. 1-3, in various embodiments, the propellant formed by method 200 may be disposed into propellant chamber 115 of rocket motor 100 (step 302). Propellant chamber 115 may comprise a mandrel disposed within propellant chamber 115, spanning part of the, or the entire, length of propellant chamber 115. The rocket motor 100 and/or propellant 120 may be heated (step 304) to cure propellant 120 in propellant chamber 115. The mandrel in propellant chamber 115 may be removed (step 306), forming cavity 117 in propellant 120.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A propellant, comprising:
a primary oxidizer having a density of greater than or equal to 2.7 grams per cubic centimeter; and
a fuel comprising at least one of zirconium metal, tin metal, tungsten metal, zinc metal, titanium metal, aluminum metal, magnesium metal, magnalium metal alloy, or a metal hydride,
wherein the propellant is substantially free of lead.

2. The propellant of claim 1, wherein the primary oxidizer comprises at least one of potassium iodate, potassium periodate, cesium iodate, cesium periodate, cupric iodate, copper periodate, or ammonium iodate.

3. The propellant of claim 2, comprising a secondary oxidizer having a density of less than 2.7 grams per cubic centimeter, wherein the secondary oxidizer comprises at least one of potassium perchlorate or ammonium perchlorate.

4. The propellant of claim 3, comprising about 50% to about 90% by weight the primary oxidizer.

5. The propellant of claim 4, comprising about 1% to about 50% by weight the secondary oxidizer.

6. The propellant of claim 5, comprising 2% to 30% by weight the fuel.

7. The propellant of claim 1, further comprising a binder comprising at least one of polyurethane, hydroxyl terminated polybutadiene, or hydroxyl terminated polyether.

8. The propellant of claim 7, comprising 3% to 14% by weight the binder.

9. The propellant of claim 7, further comprising a plasticizer comprising at least one of trimethyloethane trinitrate, triethyleneglycol dinitrate, butannetriol trinitrate, diethylene glycol dinitrate, n-butyl-2-nitratoethyl nitramine, 2,4-dinitro ethyl benzene, 2,4,6-trinitro ethyl benzene, dioctyl adipate, dibutyl phthalate, or isodecyl pelargonate.

10. The propellant of claim 9, comprising 2% to 18% by weight the plasticizer.

11. The propellant of claim 9, wherein the plasticizer comprises at least one of about 50% by weight 2,4-dinitro ethyl benzene and about 50% by weight 2,4,6-trinitro ethyl benzene, or about 50% by weight trimethyloethane trinitrate and about 50% by weight triethyleneglycol dinitrate.

12. A rocket motor, comprising:
a motor casing;
a propellant chamber within the motor casing; and
a propellant disposed within the propellant chamber comprising:
a primary oxidizer having a density of greater than or equal to 2.7 grams per cubic centimeter; and
a fuel comprising at least one of zirconium metal, tin metal, tungsten metal, zinc metal, titanium metal, aluminum metal, magnesium metal, magnalium metal alloy, or a metal hydride,
wherein the propellant is substantially free of lead.

13. The rocket motor of claim 12, wherein the primary oxidizer comprises at least one of potassium iodate, potassium periodate, cesium iodate, cesium periodate, cupric iodate, copper periodate, or ammonium iodate.

14. The rocket motor of claim 13, wherein the propellant further comprises a secondary oxidizer having a density of less than 2.7 grams per cubic centimeter, wherein the secondary oxidizer comprises at least one of potassium perchlorate or ammonium perchlorate.

15. The rocket motor of claim 12, wherein the propellant comprises about 50% to about 90% by weight the primary oxidizer.

16. The rocket motor of claim 15, wherein the propellant comprises about 1% to about 50% by weight the secondary oxidizer.

17. The rocket motor of claim 16, wherein the propellant comprises 2% to 30% by weight the fuel.

18. The rocket motor of claim 12, wherein the propellant further comprises a binder comprising at least one of polyurethane, hydroxyl terminated polybutadiene, or hydroxyl terminated polyether.

19. The rocket motor of claim 18, wherein the propellant further comprises a plasticizer comprising at least one of trimethyloethane trinitrate, triethyleneglycol dinitrate, butannetriol trinitrate, diethylene glycol dinitrate, n-butyl-2-nitratoethyl nitramine, 2,4-dinitro ethyl benzene, 2,4,6-trinitro ethyl benzene, dioctyl adipate, dibutyl phthalate, or isodecyl pelargonate.

20. A method of making a propellant, comprising:
forming an oxidizer mixture by mixing a primary oxidizer and a secondary oxidizer, wherein the primary oxidizer has a density of greater than or equal to 2.7 grams per cubic centimeter and the secondary oxidizer has a density of less than 2.7 grams per cubic centimeter; and
mixing the oxidizer mixture with a fuel and a binder, wherein the fuel comprises at least one of zirconium metal, tin metal, tungsten metal, zinc metal, titanium metal, aluminum metal, magnesium metal, magnalium metal alloy, or a metal hydride, and the binder comprises at least one of polyurethane, hydroxyl terminated polybutadiene, or hydroxyl terminated polyether.
